(19) United States
(12) Patent Application Publication
(10) Pub. No.: US 2016/0189241 A1
(43) Pub. Date: Jun. 30, 2016

(54) COST-PER- SECOND ONLINE ADVERTISEMENT RANKING METHODS AND SYSTEMS

(71) Applicant: Marc Guldimann, brooklyn, NY (US)

(72) Inventor: Marc Guldimann, brooklyn, NY (US)

(21) Appl. No.: 14/867,238

(22) Filed: Sep. 28, 2015

Related U.S. Application Data
(63) Continuation-in-part of application No. 14/730,242, filed on Jun. 4, 2015.
(60) Provisional application No. 62/007,956, filed on Jun. 5, 2014.

(51) Int. Cl. G06Q 30/02

(52) U.S. Cl. CPC G06Q 30/0272; G06Q 30/0275

(57) ABSTRACT

In one aspect, a computerized-method of matching advertisement impressions to a particular campaign implemented in an online digital-advertisement market place/exchange platform and implemented by at least one server includes the step of receiving an insertion order (IO) from an online-advertiser server, wherein the IO is received in an electronic message electronically communicated to the at least one server implementing the online digital-advertisement market place/exchange platform. The process includes the step of determining an expected time on screen for a digital advertisement. The process includes the step of determining a cost-per-second (CPS) the digital advertisement is to be displayed on a computer screen, wherein the CPS is a measure of a time a computer screen is controlled by an advertisement display of the digital advertisement. The process includes the step of algorithmically pacing an advertisement campaign that comprises the digital advertisement, wherein the digital advertisement is provided for display at a specified number of impressions per specified period of time over the course of an advertisement campaign period

### CROSS-REFERENCE TO RELATED APPLICATIONS

This application is a claims priority from U.S. application Ser. No. 14/730,242 filed 4 Jun. 2015. This application is hereby incorporated by reference in its entirety. The Ser. No. 14/730,242 application claims priority from U.S. Provisional Application No. 62/007,956 filed 5 Jun. 2014. This application is hereby incorporated by reference in its entirety

### FIELD OF THE INVENTION

The invention is in the field of digital advertisements and more specifically to a method, system and apparatus of methods and systems of cost-per-second online advertisement ranking.

### DESCRIPTION OF THE RELATED ART

Currently, online advertising and marketing related to web traffic may use cost-per-impression (or cost-per-thousand impressions) (CPM). CPM can refer to the cost of traditional advertising, Internet marketing or other advertising campaigns, where advertisers pay each time an advertisement is displayed. However, it may be difficult to quantify the effect of the advertisement on the user.

### BRIEF SUMMARY OF THE INVENTION

In one aspect, a computerized-method of matching advertisement impressions to a particular campaign implemented in an online digital-advertisement market place/exchange platform and implemented by at least one server includes the step of receiving an insertion order (IO) from an online-advertiser server, wherein the IO is received in an electronic message electronically communicated to the at least one server implementing the online digital-advertisement market place/exchange platform. The process includes the step of determining are expected tune on screen for a digital advertisement. The process includes the step of determining a cost-per-second (CPS) the digital advertisement is to be displayed on a computer screen, wherein the CPS is a measure of a time a computer screen is controlled by an advertisement display of the digital advertisement. The process includes the step of algorithmically pacing an advertisement campaign that comprises the digital advertisement, wherein the digital advertisement is provided for display at a specified number of impressions per a specified period of time over the course of an advertisement campaign period.

### BRIEF DESCRIPTION OF THE DRAWINGS

The present application can be best understood by reference to the following description taken in conjunction with the accompanying figures, in which like parts may be referred to by like numerals.

FIG. 1 illustrates an example matching process for matching advertisement impressions to a particular campaign, according to some embodiments.

FIG. 2 illustrates an example process for bidding on placement of digital advertisements using CPS bids, according to some embodiments.

FIG. 3 illustrates an example computer screen controlled by an advertisement display, according to some embodiments.

FIG. 4 depicts an example auction process to win a bid to display a digital advertisement on a web page, according to some embodiments.

FIG. 5 is a block diagram of a sample computing environment that can be utilized to implement various embodiments.

FIG. 6 depicts an exemplary computing system that can be configured to perform any one of the processes provided herein.

The Figures described above are a representative set, and are not an exhaustive set with respect to embodying the invention.

### DESCRIPTION

Disclosed are a system, method, and article of manufacture for cost-per-second online advertisement ranking. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Advertisement media can be various digital media content (e.g. digital images, digital audio files, digital videos, etc.) that can be used in online advertising. Advertisement media can be formatted and displayed in various layouts such as the mobile scrolling format provided in U.S. patent application Ser. No. 14/730,242.

Advertisement (e.g. ‘Ad’) serving describes the technology and service that places advertisements on web sites. Ad serving technology companies provide software to web sites and advertisers to serve advertisements, count them, choose the advertisements that will make the website or advertiser most money, and monitor progress of different advertising campaigns.

Cost-per-second (CPS) can measure the time a computer screen is controlled by an advertisement display. In some examples, CPS can be applied to any type of advertising that is interruptive for length of time that the reader chooses.

Cookie (e.g. an HTTP cookie) a small piece of data sent from a website and stored in a user's web browser while the user is browsing that website.

Creative identifier can be a unique identifier that describes a piece of creative so that its contents can be understood (e.g. the advertiser featured in it, the agency who designed it, etc.).

Demand-side platform (DSP) can be a system that allows buyers of digital advertising inventory to manage multiple ad exchange and data exchange accounts through one interface. Real-time bidding for displaying online advertising can take place within advertisement exchanges, and by utilizing a DSP, marketers can manage their bids for the banners and the pricing for the data that they are layering on to target their audiences.

Impression can be a delivered basic advertising unit from an advertisement distribution point.

Insertion order (IO) can be authorization to display/broadcast an advertisement. An IO can include instructions regarding the insertion time(s)/date(s), number of insertions in a stated period, ad size, and ad placement, and/or other metrics.

Mobile device can be any portable user-side computing system. Example mobile devices include, inter alia: smart phones, smart watches, head-mounted displays, other wearable computers, tablet computers, laptop computers, etc.

Supply-side platform (SSP) can include a technology platform with the mission of enabling publishers to manage their advertising impression inventory and maximize revenue from digital media.

### Exemplary Methods

In one example, pre-negotiate prices can be negotiated with advertisers on a CPS basis. The advertisement media that satisfies the terms of the insertion order (IO) can then be delivered to the advertiser. The advertisement media can be delivered across a network of websites. In one example, an IO can stipulate the following conditions, inter alia: one-hundred (100) hours of time; capped at ten (10) seconds per user per day; served on specified websites (e.g. www.espn.com, www.cnn.com, etc.).

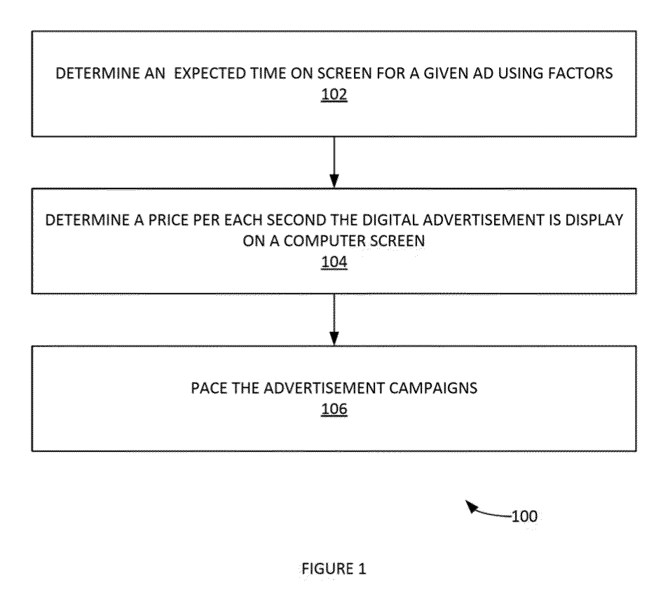

In one example, a system administrator can manually manage the delivery of the advertisement media according to IO terms. In another example, a computerized system can be utilized to automatically implement a system that targets advertisements to effect a specified time yield from given impressions. The computerized system can manage delivery of several advertisement campaigns and be responsible for matching any given impression to an advertisement campaign. For example, FIG. 1 illustrates an example matching process 100 for matching advertisement impressions to a particular campaign, according to some embodiments. In step 102, process 100 determines an expected time on screen for a given advertisement using various factors. Exemplary factors can include, inter alia: historical time screen, situational factors (e.g. location, time of day, device type), contextual data (e.g. the identity, of the website site the digital advertisement is being served on) behavioral data, demographic data, etc.

In step 104, process 100 can determine a cost-per-second the digital advertisement is to be displayed on a computer screen (e.g. a touchscreen, a television screen, a computer-display screen, etc.). For example, a CPS can be determined and set for the particular digital advertisement. In a direct-sold method example, the price can be pre-negotiated. In a programmatic method, the price can be sent via a bid. In step 105, process 100 can pace the advertisement campaigns. For example, process 100 can deliver the advertisement campaigns in an evenly-paced manner such that it delivers roughly the same amount of impressions hourly over the course of the advertisement campaign.

Process 100 can maximize the total revenue (e.g. as calculated, by CPS× seconds yielded) with as set of digital advertisement(s) from a given set of impressions while remaining within the constraints of the advertisement campaign and pacing said advertisement campaign evenly. Process 100 can enable an advertiser to implement audience targeting (e.g. whereby advertisements are placed so as to reach consumers based on various traits such as demographics, psychographics, behavioral variables (such as product purchase history), etc.). For example, an advertiser can identify a certain set of users a cookie and/or pseudo cookie. In this instance, process 100 can consider the advertisement for serving if the impression was seen by someone in the advertisers defined audience.

It is noted that process 100 can be implemented in an online digital advertisers market place/exchange platform. In one example, advertisers can bid on a CPS basis in an online marketplace. The online marketplace can manage and enable auctions to determine digital advertisement placement. In one example an online auction can be implemented as follows. Once we have a pool of eligible digital advertisements is collected, the digital-advertisements auction can be used to determine which of those digital advertisements is to be displayed on a web page accessed by a specified user's computing device (e.g. a mobile device's web browser). The bid rank, but not the actual fee, can then be computed. In a marketplace/programmatic embodiment, the actual fee=CPS bid used to beat second price (e.g. this is a second price auction)*the amount of time on screen that is observed after the impression.

For each eligible digital advertisement, an advertisement bid rank can be calculated by combining the CPS bid and the digital advertisement's Quality Score. In this particular digital advertisement ranking example, an advertiser with a low CPS bid but a high Quality Score may win the auction against another competitor whose CPS bid is higher but who has digital advertisement creatives that are not interesting and are not likely to have time spent with them. It is noted that in the dynamic auction-based system the price the winner pays can vary from auction to auction, and from digital-advertisement impression to digital-advertisement impression, depending on the advertisers' Quality Score for that web page and on the level of auction competition. In one example, a Quality Score can be a measure of how useful a digital advertisement is to the use that views/experiences. A Quality Score can be based on several factors, including, inter alia: the digital advertisement's predicted time on screen based on its past performance on a specified set of web sites; various relevance factors, such as the relevance of the advertiser's digital advertisement and keywords to a web site; etc.

In one example, bids can be obtained in real time (e.g. assuming various system and networking latencies, etc.) from an external source (e.g. an external bidder entity, etc.). Quality Score calculations can be implemented to determine which impression is expected to yield the most time (e.g. a ToS value). This can be used to factor an incoming CPS bid with the goal of extracting the most revenue from each impression.

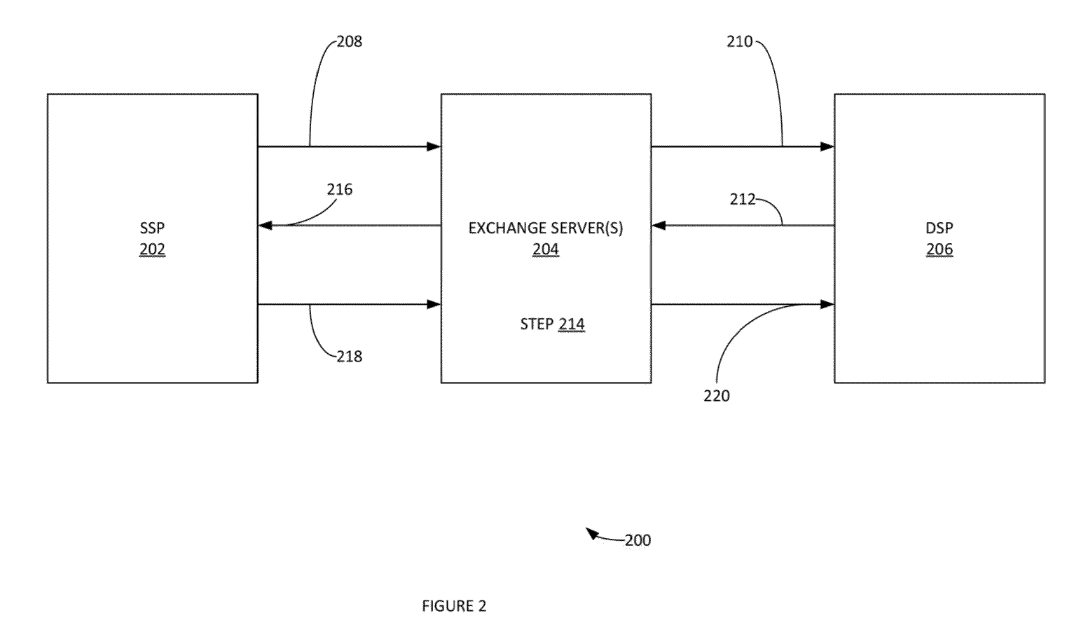

FIG. 2 illustrates an example process 200 for bidding on placement of digital advertisements using CPS bids, according to some embodiments. Process 200 can be implemented with an example computer system provided in FIG. 2. Example computer system can include: SSP 202, exchange server(s) 204, and/or DSP 206. SSP 202 can include, inter alia, an ad server that places advertisements on web sites. Exchange server(s) 204 can manage auctions (e.g. determine CPS values, determine Quality Scores, receive bids for advertisements, provide bid/user information to advertisers) server(s), etc.). For example, exchange servers) 204 can manage the online marketplace provided supra.

In steps 208 and 210, process 200 can generate a bid request and forward bid requests to advertisers. For example, the bid request is issued by the SSP 202. The bid request can include the URL of the webpage the digital advertisement can run on and a cookie and/or pseudo cookie identifier. The exchange server(s) can receive the bid request and forward it to the advertiser (e.g. to DSP 206). In step 212, process 200 can receive the bid response. The bid response can include a CPS bid and a creative identifier. In some examples, a bid can be based on a per-impression price model. In step 214, the exchange server(s) 204 can implement an auction. Using historical data tied to the creative identifier, the exchange server(s) 204 can calculate a quality score for each digital advertisement. The quality score can be used to weigh the bids such that the digital advertisement with the highest expected-value wins the auction. A bid rank value can be calculated as follows: Bid Rank=Bid (CPS)× Quality Score.

In step 216, process 200 can process the winning digital advertisement. The exchange server(s) 204 can communicate various details about the winning digital advertisement to SSP 202. SSP 202 can hen instruct the ad server to render a specific digital advertisement on the webpage. The details can be a digital advertisement identifier that the ad server includes information about, such as an identifier so that the ad server may look the creative tag up in its own database, or a JavaScript tag that will cause the browser it is rendered on to download and display the creative. In step 218, process 200 can monitor digital advertisement performance. For example, SSP 202 can report back to exchange server(s) 204 and DSP 206 with various performance metrics.

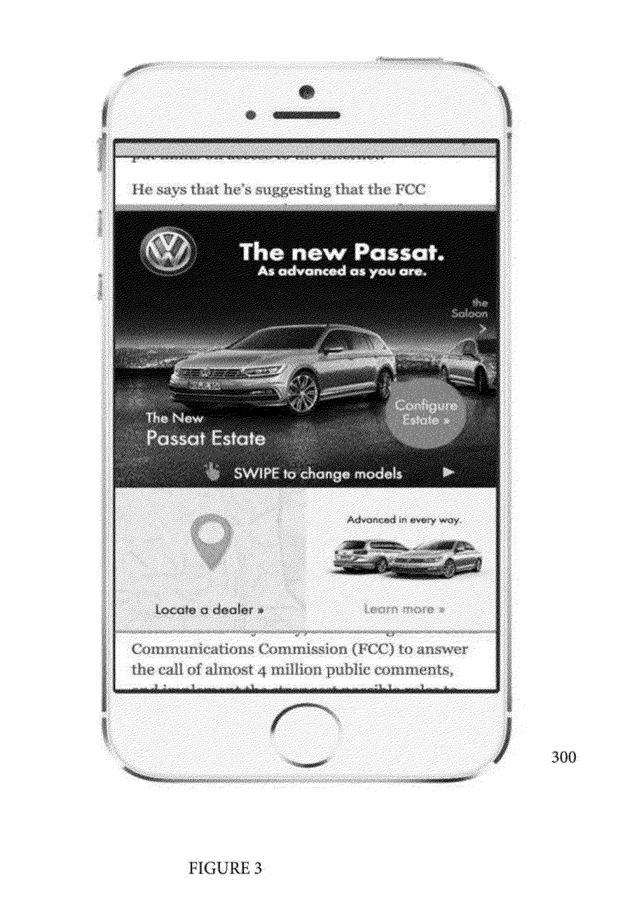

FIG. 3 illustrates an example computer screen 300 controlled by an advertisement display, according to some embodiments. The particular advertisement display of FIG. 3 is provided as mobile scrolling advertisement format. The time on screen (ToS) of the advertisement can be recorded. This information can be utilized to determine a CPS value of the advertisement.

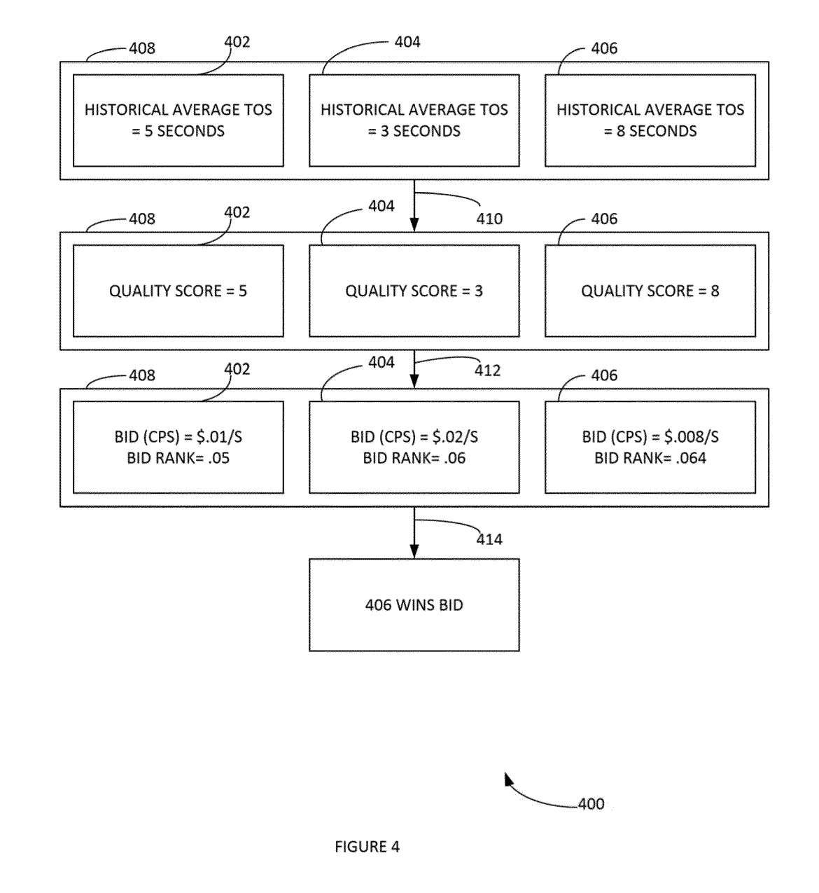

FIG. 4 depicts an example auction process 400 to win a bid to display a digital advertisement on a web page, according to some embodiments. A set of digital advertisements 408 can include digital advertisement 402, digital advertisement 404, digital advertisement 406, etc. A historical average ToS can be calculated for digital advertisements 402-406.

The ToS scores can be used to determine a Quality Score in step 410. In some embodiments, the Quality Score can be used predict a digital advertisement's ToS. In one example, it can be a one-to-one (1:1) ratio with an historic time on screen, as shown here, or a more complicated predictive algorithm that takes into account audience, context and environmental factors (e.g. the algorithm can take into account as many factors as possible to make the most accurate prediction about how long each advertisement might be on display for a specific impression).

In step 412, a set of CPS bids can be received for each digital advertisement. For example, digital advertisement 402 can submit a CPS bid for $0.01/second; digital advertisement 404 can submit a CPS bid for $0.02/second; digital advertisement 406 can submit a CPS bid for $0.008/second; etc. The CPS bids and Quality Scores can be used to calculate a bid rank score for each digital advertisement. The present example uses the equation Bid Rank=Bid (CPS)× Quality Score. Accordingly, digital advertisement 402 can receive a bid rank of 0.05; digital advertisement 404 can receive a bid rank of 0.06; digital advertisement 406 can receive a bid rank of 0.064; etc. A digital advertisement with the highest bid rank score can be selected as the winning bid in step 414. For example, digital advertisement 406 has the highest bid rank score and thus can be selected as the winning bid. Digital advertisement 406 can be managed by an ad server for display on a specified web page.

Various methods of backwards compatibility to CPM are now discussed. CPM bids can be converted to CPS by dividing the bid amount by the expected time on screen with a risk premium. (1/ToS(Bid))*(1−X % risk premium). For example, if there was a twenty-percent (20%) risk premium, a $0.01 impression bid with an expected ToS of four (4) seconds can bid 002 CPS, with a quality score of 4. The advertiser can pay the same amount regardless of the time the digital advertisement is displayed on the computer screen. CPM bids can be viewable impressions.

### Systems and Architecture

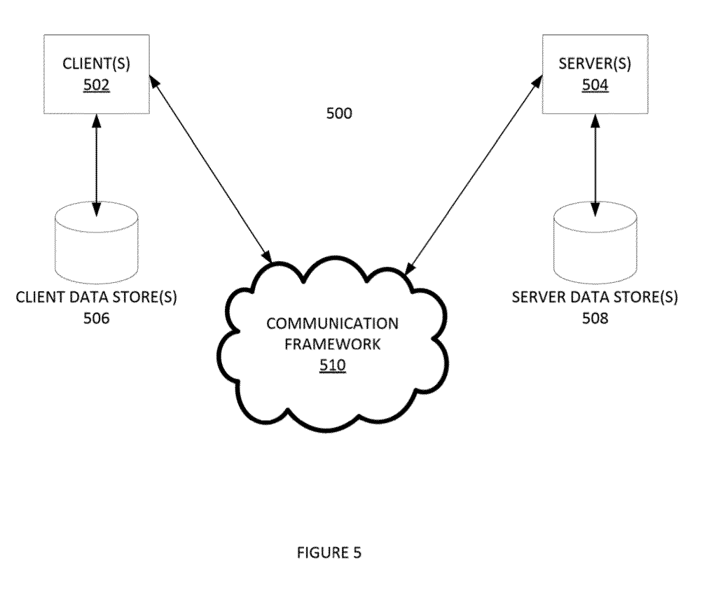

FIG. 5 is a block diagram of a sample computing environment 500 that can be utilized to implement various embodiments. The system 500 further illustrates a system that includes one or more client(s) 502. The client(s) 502 can be hardware and/or software (e.g., threads, processes, computing devices). The system 500 also includes one or more server(s) 504. The server(s) 504 can also be hardware and/or software (e.g., threads, processes, computing devices). One possible communication between a client 502 and a server 504 may be in the form of a data packet adapted to be transmitted between two or more computer processes. The system 500 includes a communication framework 510 that can be employed to facilitate communications between the client(s) 502 and the server(s) 504. The client(s) 502 are connected to one or more client data store(s) 506 that can be employed to store information local to the client(s) 502. Similarly, the server(s) 504 are connected to one or more server data stores(s) 508 that can be employed to store information local to the server(s) 504.

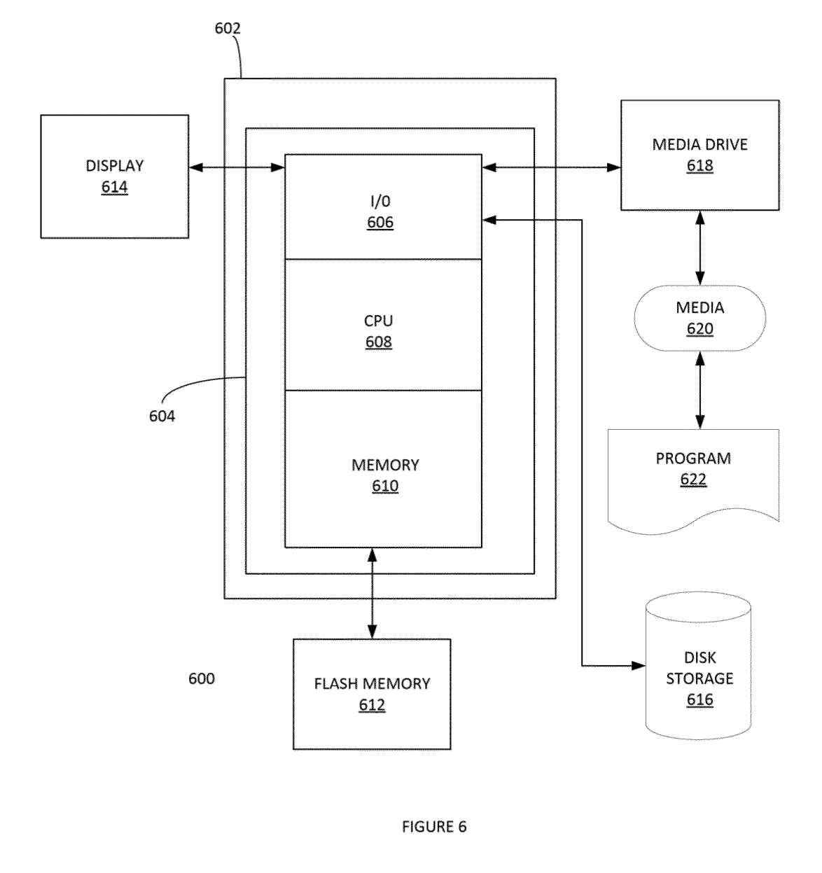

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main gain system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi Bluetooth® (and/or other standards for exchanging data over short distances includes those using short-wavelength radio transmission), USB, Ethernet, cellular, an ultrasonic local area communication protocol, etc. Instructions for implementing the methods provided herein (e.g. processes 100-400, etc.) can be stored in memory 610 and run by CPU 608.

### EXAMPLE USE CASES

The following example use cases can be implemented in a computing environment. Information utilized in the use cases can be parsed and stored in databases and/or formatted for communication between computing devices such as servers, mobile devices, etc. The computing devices can include software and/or hardware systems for parsing, storing, electronically communicating and/or rendering the information for display on a computer screen. Information used herein can also be stored in a computer memory.

In some embodiments, methods and systems of cost-per-second online advertisement ranking can be implemented as a product. The product can be formatted as a rich-media tool. A publisher can use the product to charge higher advertisement rates on their mobile websites. The product can provide more impact and, accordingly, publishers can request higher rates from advertisers. The product can use time as a metric of the value of an impression (e.g. on a cost-per-second basis). The product can measure the amount of time that a user engages with an advertisement on a webpage. Calculations can be performed by server-side computer processors that obtain the information from the databases and/or server memory systems.

The product can ‘sit’ between the advertiser and the publisher. For example, the product can be used to mediate advertisement sales between the advertiser and the publisher. The advertiser can provide a payment amount per second (or other time period). The publisher can then run the advertisement and charge the advertiser based on the amount of time that the user engages with the advertisement. The product can be used to pay the publisher on a CPM model. The product can sell the advertisement space to advertisers on a cost-per-second basis. Accordingly, advertisers are able to purchase user attention on a cost-per-second basis. The advertisers can then pay for only the amount of time that the users chose to engage with their advertisements that are published on the publisher's website. The cost-per-second basis can offer a lower risk model for the advertisers than a CPM model. At the same time, publishers can still utilize the CPM model.

In one example, an advertisement can purchase five-thousand dollars ($5,000) of one penny ($0.01) per second to display an advertisement to obtain five-hundred thousand (500,000) seconds of display the advertiser's advertisement. The product can optimize, on a per-impression basis, which advertisement is to be on the computer screen the longest. The negotiated cost-per-second price can be factored into this calculation. The yield-per-impression value can be maximized by increasing the time a user views the impression. The product can then pay the publisher on a CPM basis while charging the advertiser on a cost-per-second basis.

In one example, an advertising platform can be created and managed. The advertising platform can enable various entities to transact (e.g. allow advertisers and/or publishers to purchase and/or sell web-based advertisements) on a cost-per-second basis. The advertisement platform can implement the product discussed supra. The advertisement platform can include an advertising exchange that enables publishers to sell their inventory to advertisers. In practice, a publisher can run an advertisement tag on the publisher's web page. Whenever the advertisement tag is called, the advertisement platform can inform the advertisers that the impression is about to run (e.g. send a digital message to one or more advertiser servers). The advertisement platform can then field one or more bids from the advertisers (e.g. receive bids in the form of messages communicated to an advertisement platform server from the advertiser's servers over a computer network). The bids can be in cost-per-second terms. The bid can also include a creative identifier, an advertiser identifier, an agency identifier, etc. This information can be stored in a database. The advertisement platform can calculate the wining bid based on one or more equations for determining a bid rank (e.g. as provide supra). Factors that can be included in an equation for determining a bid rank include, inter alia: publisher identity, time of day of advertisement display, geography of display, historical time on screen for relevant characteristics, website, end-user demographics, etc. These can be used to predict how long each advertisement will likely be on the screen. This predication value can be used to weight a bid. Once the bid has been weighted, the bid score can be determined. In others words, an historical time-on-screen for an advertisement and/or a predicted time-on-screen for an advertisement can be used to weight a submitted bid. The weighted value can be multiplied by a bid to yield an expected value for every advertisement bidding for a particular impression. The advertisement with the highest expected value can be run. The weighting effect can be used to help ensure that the winning advertisements are likely to be of interest to the user.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized-method of matching advertisement impressions to a particular campaign implemented in an online digital-advertisement market place/exchange platform and implemented by at least one server comprising:
receiving an insertion order (IO) from an online-advertiser server, wherein the IO is received in an electronic message electronically communicated to the at least one server implementing the online digital-advertisement market place/exchange platform;
determining an expected time on screen for a digital advertisement;
determining a cost-per-second (CPS) the digital advertisement is to be displayed on a computer screen, wherein the CPS is a measure of a time a computer screen is controlled by an advertisement display of the digital advertisement;
algorithmically placing an advertisement campaign that comprises the digital advertisement, wherein the digital advertisement is provided for display at a specified number of impressions per a specified period of time over the course of an advertisement campaign period.

2. The computerized-method of claim 1, wherein the expected time on screen for a given advertisement is determined based on an historical time on screen for the digital advertisement, an identity of the website site the digital advertisement is being served on, a user-behavioral data, or a user-demographic data.

3. The computerized-method of claim 2, wherein the CPS is pre-negotiated with an advertiser that manages the online-advertiser server.

4. The computerized-method of claim 2, wherein the CPS via a bid in an electronic message to the at least one server implementing the digital-advertisement market place/exchange platform.

5. The computerized-method of claim 2, wherein the CPS comprises is applied to an digital advertisement type is interruptive for a length of time that a user of a displaying computing device chooses.

6. The computerized-method of claim 3, wherein the at least one server implementing the online digital-advertisement market place/exchange platform provides an online marketplace that receives one or more bids in the form of an electronic message, wherein a bid comprises an offer the advertiser is willing to pay on a CPS basis for the display of a digital advertisement, and wherein the bid is provided in an digital-advertisements auction.

7. The computerized-method of claim 6, wherein the at least one server implementing the online digital-advertisement market place/exchange platform receives a pool of eligible digital advertisements and stores the pool of eligible digital advertisements in a memory of the at least one server.

8. The computerized-method of claim 7, wherein the at least one server implementing the online digital-advertisement market place/exchange platform implements the digital-advertisements auction used to determine which of the pool of eligible digital advertisements is displayed on a web page accessed by a specified user's computing device.

9. The computerized-method of claim 8, wherein an actual fee for display of the digital advertisement is a CPS bid that beats a second-placed bid price times an amount of time the digital advertisement is presented on the digital screen.

10. A computerized system for matching advertisement impressions to a particular campaign implemented in an online digital-advertise market place/exchange platform implemented by at least one server comprising:
a processor configured to execute instructions;
a memory containing instructions when executed on the processor, causes the processor to perform operations that:
receive an insertion order (IO) from an online-advertiser server, wherein the IO is received in an electronic message electronically communicated to the at least one server implementing the online digital-advertisement market place/exchange platform;
determine an expected time on screen for a digital advertisement;
determine a cost-per-second (CPS) the digital advertisement is to be displayed on a computer screen, wherein the CPS comprises a measure of a time a computer screen is controlled by an advertisement display of the digital advertisement;
algorithmically pace an advertisement campaign that comprises the digital advertisement, wherein the digital advertisement is provided for display at a specified number of impressions per a specified period of time over the course of an advertisement campaign period.

11. The computerized-system of claim 10, wherein the expected time on screen for a given advertisement is determined based on an historical time on screen for the digital advertisement, an identity of the website site the digital advertisement is being served on, a user-behavioral data, or a user-demographic data.

12. The computerized-system of claim 11, wherein the CPS is pre-negotiated with an advertiser that manages the online-advertiser server.

13. The computerized-system of claim 11, wherein the CPS via a bid in an electronic message to the at least one server implementing the digital-advertisement market place/exchange platform.

14. The computerized-system of claim 13, wherein the CPS comprises is applied to a digital advertisement type is interruptive for a length of time that a user of a displaying computing device chooses.

15. The computerized-system of claim 10, wherein the at least one server implementing the online digital-advertisement market place/exchange platform provides an online marketplace that receives one or more bids in the form of an electronic message, wherein a bid comprises an offer the advertiser is willing to pay on a CPS basis for the display of a digital advertisement, and wherein the bid is provided in an digital-advertisements auction.

16. The computerized-system of claim 15, wherein the at least one server implementing the online digital-advertisement market place/exchange platform receives a pool of eligible digital advertisements and stores the pool of eligible digital advertisements in a memory of the at least one server.

17. The computerized-system of claim 16, wherein the at least one server implementing the online digital-advertisement market place/exchange platform implements the digital-advertisements auction used to determine which of the pool of eligible digital advertisements is displayed on a web page accessed by a specified user's computing device.

18. The computerized-system of claim 17, wherein an actual fee for display of the digital advertisement is a CPS bid that beats a second-placed bid price times an amount of time the digital advertisement is presented on the digital screen.
